(19) United States
(12) Patent Application Publication
(10) Pub. No.: US 2026/0136432 A1
(43) Pub. Date: May 14, 2026

(54) BINDING SUPPORT FUNCTION NOTIFICATION TO POLICY CONTROL FUNCTION FOR SESSION LEGITIMACY AUDIT

(71) Applicant: T-Mobile Innovations LLC, Overland Park, KS (US)

(72) Inventor: Suryaprakash Reddy VOODEM, Bothell, WA (US)

(21) Appl. No.: 18/944,420

(22) Filed: Nov. 12, 2024

(51) Int. Cl. H04W 76/34

(52) U.S. Cl. CPC H04W 76/34

(57) ABSTRACT

Methods and systems described herein provide for removing stale bindings of inactive sessions on a network. A method comprises creating a session binding in a wireless network database, determining whether a session binding removal notification from a policy control function (PCF) to delete the session binding from the network database has reached a binding support function (BSF), and, in response to determining that the session binding removal notification has not reached the BSF, removing the session binding at the BSF.

### TECHNICAL BACKGROUND

As wireless networks evolve and grow, there are ongoing challenges in communicating data across different types of networks. For example, a wireless network may include one or more access nodes, such as base stations, including, for example evolved NodeBs (eNodeBs or eNBs) and next generation NodeBs (gNodeBs or gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G and millimeter wave (mm-wave) networks, as well as 4G long-term evolution (LTE) access nodes.

5G networks include a core network utilizing a service based architecture (SBA) and further follow the separation of control plane and user plane functionalities (CUPS). Wireless devices communicating with the base station or access node receive service from the wireless network based on quality of service. In addition, the network processing system includes a processor and storage space that stores instructions to be executed by the processor, as well as sessions established for particular subscribers, and session bindings for various network slices.

Implementation of session management and network slice binding management involves a specific 3GPP standard flow between network functions including the binding support function (BSF), policy control function (PCF), session management function (SMF), network exposure function (NEF), and application function (AF). A protocol data unit (PDU) session in a 5G network is a logical connection established between the UE and the 5G core network for the transmission and reception of data.

The SMF in the 5G core handles the creation, modification, and deletion of PDU sessions. For example, the SMF assigns an address of a session that carries IPv6 packets to the UE (e.g., with subscription permanent identifier (SUPI) or generic public subscription Identifier (GPSI)) and sends this information to PCF. The PCF then creates a policy session and sends the binding information to the BSF. The BSF then stores the session binding in the network database.

Currently, there is no way for the BSF to know whether the session is legitimate after a certain time period, as there is no additional signaling to the BSF from the PCF after the session creation. Accordingly, some sessions may become stale if no indication from the SMF reaches the PCF, or if instructions to delete the session binding are missing from the PCF to the BSF due to congestion or transport issues or system overload. Either of these scenarios create a need for a stale binding clean-up mechanism on the BSF.

### OVERVIEW

Exemplary embodiments provided herein include a method that includes the steps of creating a session binding in a wireless network database, determining whether a session binding removal notification from a policy control function (PCF) to delete the session binding from the network database has reached a binding support function (BSF), and in response to determining that the session binding removal notification has not reached the BSF, removing the session binding at the BSF. The method may further comprise the steps of establishing the session in the wireless network database by a session management function (SMF) and notifying the PCF by the SMF, and instructing the BSF, by the PCF, to create the session binding in the wireless network database.

In one implementation, the method comprises deleting the session on the network by the SMF, determining whether a session deletion notification from the SMF has reached the PCF, and in response to determining that the session deletion notification has not reached the PCF, deleting the session binding at the PCF. Upon expiration of a predetermined period of time, the BSF may query the PCF for a session for the session binding. Further, in response to the query by the BSF, the PCF may return an error message to the BSF indicating the session for the session binding is inactive.

In another implementation, the method includes, in response to receiving the error message, deleting the session binding at the BSF. The PCF may query a session management function (SMF) for a session for the session binding. In response to the query by the PCF, the SMF returns an error message to the PCF indicating the session for the session binding is inactive. The method may further comprise, in response to receiving an error message from the SMF, deleting the session binding at the PCF.

Other exemplary embodiments provided herein include a system comprising a memory storing instructions and data including a subscription uplifting a quality of service for a wireless device, and at least one processor executing the stored instructions to perform a set of operations. The operations may instruct to create a session binding in a wireless network database, determine whether a session binding removal notification from a policy control function (PCF) to delete the session binding from the network database has reached a binding support function (BSF), and in response to determining that the session binding removal notification has not reached the BSF, remove the session binding at the BSF.

In addition, certain exemplary embodiments provided herein include a non-transitory computer readable medium storing instructions executed by a processor to perform a set of operations. The steps of the operations may comprise: creating a session binding in a wireless network database, determining whether a session binding removal notification from a policy control function (PCF) to delete the session binding from the network database has reached a binding support function (BSF), and in response to determining that the session binding removal notification has not reached the BSF, removing the session binding at the BSF.

### BRIEF DESCRIPTION OF THE DRAWINGS

FIG. 1 depicts an exemplary environment for a BSF session clean up system in accordance with an embodiment.

FIG. 2 depicts a session clean-up mechanism in accordance with an embodiment.

FIG. 3 depicts a session clean-up mechanism operating within a core network in accordance with an embodiment.

FIGS. 4A-C are diagrams exemplifying certain interactions of control plane functions with and without session binding clean-up mechanism.

FIGS. 5A-B are diagrams exemplifying certain interactions of control plane functions with and without session binding clean-up mechanism.

FIG. 6 depicts an exemplary method for session binding clean-up in accordance with an embodiment.

### DETAILED DESCRIPTION

In embodiments disclosed herein, a session binding clean-up mechanism that interacts with control plane functions ensures that sessions removed from the database by a policy control function (PCF) also have the session binding removed from the database by a binding support function (BSF). Embodiments disclosed herein ensure that the BSF deletes a session binding even when a notification to delete a session does not reach the PCF, or even when the notification to delete a session does reach the PCF, but a notification to delete a session binding is not provided to the BSF.

The SMF in the 5G core handles the creation, modification, and deletion of PDU sessions. For example, the SMF may assign an address of a session that carries IPv6 packets to the UE (e.g., with subscription permanent identifier (SUPI) or generic public subscription Identifier (GPSI)) and sends this information to PCF. The PCF then creates a policy session and sends the binding information to the BSF.

When the PDU session is established by the SMF, the PCF sends an acknowledgment/confirmation message, e.g., a 201 message to the SMF that the PDU session is created. Then, the PCF copies this information to the BSF. The session formed, for example, by a mobile subscriber that is identified by a subscription permanent identifier (SUPI) is stored by the BSF according to the session’s binding information identified by the internet protocol version 6 (IPv6), for example. The BSF sends an acknowledgment/confirmation message, e.g., a 200 message to the PCF that the PDU session binding is created. The session by the mobile subscriber may be maintained, updated or eventually deleted.

In instances when the SMF updates a session, the SMF notifies the PCF, when a confirmation notification, e.g., a 200 message is sent back from the PCF to the SMF. Similarly, when the SMF deletes a session, the SMF informs the PCF and the PCF responds with an acknowledgement notification to the SMF, and as a result, the PCF deletes the session from the database. One of the benefits of the SMF deletion notice reaching the PCF is in the storage capacity of the database not being wasted by stale sessions. In turn, when the PCF deletes the session from the database, a related binding of the session that is stored in the database by the BSF needs to be removed from the database, in order to free up the storage capacity of the database from stale session bindings.

For this clean-up process to occur, typically the notification of the deletion needs to properly reach the PCF, and the subsequent notification sent by the PCF needs to arrive at the BSF, for the BSF to delete the binding identified by the IPV6, for example. In some cases, when the SMF releases an IPv6 address due to UE deregistering from the network, for example, the network may be congested, or the PCF may otherwise not be able to process the notification to delete. The PCF may have its own session clean up mechanism based on respective vendors/operators. The PCF may audit the stale sessions and instruct the SMF to determine whether a stale session is active or not. If the SMF does not respond, e.g., due to inability to locate the session, the PCF removes the inactive session from the database as a result of receiving a 404 message. Nonetheless, in some instances, the PCF may not automatically alert the BSF of the session deletion resulting from the PCF clean-up. In this manner, stale bindings may linger and the same subscriber may have multiple session requests on the network, thereby wastefully using up the resources of the network database.

In certain implementations, the BSF uses a session binding clean-up mechanism to perform removal of the inactive (stale) session bindings, even when the notification of the deletion does not reach the PCF, or even when the notification of the deletion reaches the PCF, but the subsequent notification sent by the PCF does not arrive at the BSF.

In addition to the systems and methods described herein, non-transitory computer-readable mediums may store the operations for the instructions or methods. Further, processing nodes on the network may execute the instructions or methods. The processing node may include a processor included in the SMF, the PCF, and/or the BSF or a processor included in any controller node in the wireless network.

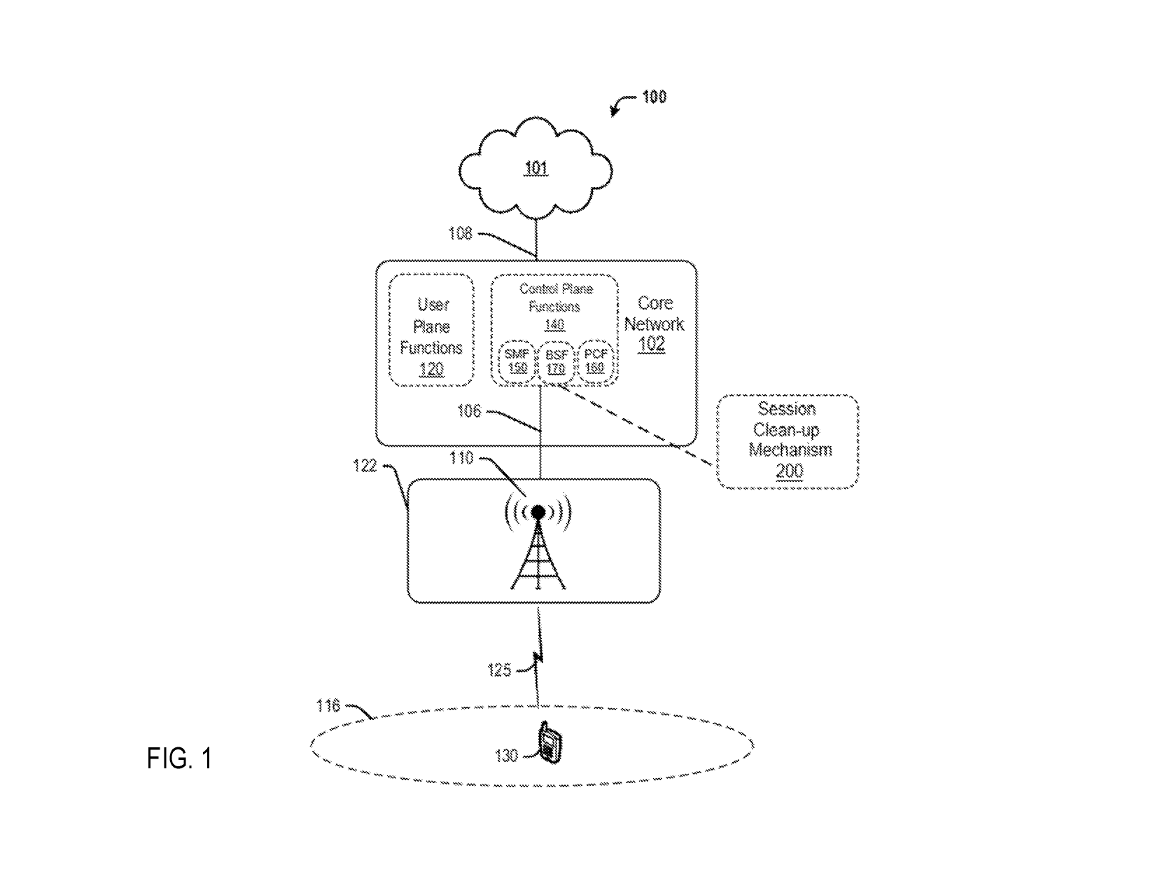

FIG. 1 depicts an exemplary environment 100 for implementing a session clean-up mechanism 200. Environment 100 comprises a communication network 101, core network 102, and a radio access network (RAN) 122 including at least an access node 110. Wireless device 130 is located in a coverage area 116 and communicates with the access node 110 over communication link 125. Although only one wireless device 130 is shown, it should be understood that any number of wireless devices could be included. Further, the session clean-up mechanism 200 interacts with the core network 102 to monitor synchronization between components of the core network 102, or more specifically control plane functions 140 including at least an SMF 150, a PCF 160, and a BSF 170.

In one implementation, the BSF 170 enables secure and efficient access to services by managing binding between application functions (AF) and network functions (NF) in the context of network slice selection function (NSSF) and network exposure function (NEF). The BSF 170 may be an integral part of the core network 102 architecture involved in the process of secure access for application-level services. The binding between the AF and the NF allows for efficient communication and ensures that the correct network policies are applied to the appropriate user or application traffic. The binding may further ensure that once the device 130 (or application) is authenticated and identified, the network 101 knows how to route the traffic and apply the correct policies.

The BSF 170 may interact with the NEF to manage how external applications securely interact with the network 101. For example, in 5G networks, slicing allows the creation of virtual networks with different characteristics (e.g., low-latency slices for gaming, high-bandwidth slices for video streaming, and energy-efficient slices for IoT). The BSF 170 may support binding within the network slices by managing the association between a network slice and the application traffic that uses the slice. The BSF 170 ensures that the correct resources and policies are applied to traffic flowing through different network slices.

Accordingly, the BSF 170 interacts with the PCF 160 to ensure that the correct policies, such as quality of service and charging, are applied to the PDU sessions. Moreover, the BSF 170 ensures that the AF is correctly bound to the policy and charging rules for a specific service or session, which may be of particularly importance for applications that require differentiated services based on priority, bandwidth, or latency.

The PCF 160 is a functional element for policy control decisions. Among other functions, the PCF 160 provides policy rules for application and service data flow detection, gating, and QoS processing. The SMF 150 and the PCF 160 work together closely to manage data sessions and apply appropriate policies to those sessions. In one implementation, when the SMF 150 sets up a new session for a user or device, the SMF 150 contacts the PCF 160 to determine the policies that should apply to that session. The PCF 160 may respond with the relevant policy rules, which may include QoS parameters (the required latency, bandwidth, and jitter limits for the session), charging rules determining how a user will be billed for the session (e.g., based on data usage, session duration, etc.), and access control, for example, whether the user is allowed to access specific services, like video streaming or VoIP.

In terms of the interaction between the PCF 160 and the BSF 170, the BSF 170 ensures that devices and users are securely authenticated and that cryptographic keys are properly managed. Once the authentication is in place, the PCF 160 can apply policy rules for the authenticated user or device. For example, after the device 130 is authenticated through the BSF 170, the PCF 160 may enforce specific policies for the device 130, such as guaranteeing a certain bandwidth for a connected IoT sensor or ensuring low latency for a mission-critical service. In addition, the PCF 160 and the BSF 170 may be responsible for the combined security and policy management. The BSF 170 provides secure access to the network 101, while the PCF 160 ensures that this access is controlled based on policies, such as which services the user can access, how much bandwidth they are allowed to use, and how they are billed for their usage.

The session clean-up mechanism 200 is illustrated as communicating with or incorporated in the core network 102. In some embodiments, the session clean-up mechanism 200 may be incorporated in the BSF 170. The core network 102 may be structured using a service based architecture (SBA) utilizing core network functions and elements including user plane functions (UPFs) 120 and control plane functions 140. The control plane functions 140 include at least the SMF 150, the PCT 160, and the BSF 170, and may further include the additional components described herein.

In an SBA architecture, service-based interfaces may be utilized between control plane functions 140, while multiple UPFs 120 connect over point-to-point link. The UPF 120 accesses a data network, such as network 101, and performs operations such as packet routing and forwarding, packet inspection, policy enforcement for the user plane, quality of service (QoS) handling, etc. In addition to the SMF 150, the PCF and the BSF 170, the control plane functions 140 may include, for example, an application function (AF), a charging function (CHF), a network exposure function (NEF), a network slice selection function (NSSF), a network repository function (NRF), a unified data management (UDM) function, an access and mobility function (AMF), and an authentication server function (AUSF). Additional or fewer control plane functions may also be included. The AMF receives connection and session related information from the wireless device 130 and is responsible for handling connection and mobility management tasks. The UDM function provides services to other core functions, such as the AMF, SMF, and NEF. The UDM may function as a stateful message store, holding information in local memory. The NSSF can be used by the AMF to assist with the selection of network slice instances that will serve a particular device.

The RAN 122 can include various access network functions and devices disposed between the core network 102 and the end-user wireless device 130. For example, the RAN 122 includes at least an access node (or base station), such as an eNodeB and/or a next generation NodeB (gNodeB) 110 communicating with a plurality of end-user wireless device 130. Further, either of core network 102 and radio access network 122 can include one or more of a local area network, a wide area network, and an internetwork (including the Internet) and capable of communicating signals and carrying data, for example, to support voice, push-to-talk, broadcast video, and data communications by end-user wireless device 130.

Access node 110 can be any network node configured to provide communication between end-user wireless device 130 and communication network 101, including standard access nodes and/or short range, low power, small access nodes. For instance, access node 110 may include any standard access node, such as a macrocell access node, base transceiver station, or a radio base station, or the like. In embodiments further discussed herein, the access node 110 is a next generation NodeB (gNB). However, the access node 110 may include multiple co-located access nodes, such as a combination of eNodeBs and gNodeBs. Access node 110 can be a small access node including a microcell access node, a picocell access node, a femtocell access node, or the like such as a home NodeB or a home eNodeB device. Moreover, it is noted that while access node 110 and wireless device 130 are illustrated in FIG. 1, any number of access nodes and wireless devices can be implemented within environment 100.

As further described herein, by utilizing antennas, access node 110 can deploy a wireless air interface 125 using one or more frequency bands over one or more coverage areas 116. Further, the different sets of antennas can be used to implement various transmission modes or operating modes in each sector, including but not limited to multiple in multiple out (MIMO), carrier aggregation (including inter-band and intra-band carrier aggregation), and different duplexing modes including frequency division duplexing (FDD) and time division duplexing (TDD).

Wireless device 130 may be any device, system, combination of devices, or other such communication platform capable of communicating wirelessly with access node 110 using one or more frequency bands deployed therefrom. Wireless device 130 may be, for example, a mobile phone, a wireless phone, a wireless modem, a personal digital assistant (PDA), a voice over internet protocol (VoIP) phone, a voice over packet (VOP) phone, a soft phone, a home internet (HINT) device, a fixed wireless access (FWA) device as well as other types of devices or systems that can exchange audio or data via access node 110. The FWA devices may include, for example, customer premises equipment (CPE). Additionally, wireless devices have evolved to include Internet of things (IoT) devices, which describes the network of physical objects or things that are embedded with sensors, software, and other technologies for the purpose of connecting and exchanging data with other devices and systems over the Internet. As set forth above, the wireless device 130 may utilize different applications at different times, which may cause them to be assigned to different network slices or receive a different QoS. The wireless device 130 can be end-user wireless devices (e.g., user equipment (UEs)) utilizing communication links 125, which may operate based on 6G, 5G new radio (NR), 4G long term evolution (LTE), or any other suitable type of ratio access technology (RAT).

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless device 130. Wireless network protocols can comprise multimedia broadcast multicast services (MBMS), code division multiple access (CDMA) single-Carrier radio transmission technology (1xRTT), Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

Communication links 106 and 108 can use various communication media, such as air, space, metal, optical fiber, or some other signal propagation path - including combinations thereof. Communication link 106 can be wired or wireless and use various communication protocols such as Internet, Internet protocol (IP), local-area network (LAN), optical networking, hybrid fiber coax (HFC), telephony, T1, or some other communication format - including combinations, improvements, or variations thereof. Wireless communication links can be a radio frequency, microwave, infrared, or other similar signal, and can use a suitable communication protocol as described herein. Communication link 106 can be a direct link or might include various equipment, intermediate components, systems, and networks. Communication links 106 may comprise many different signals sharing the same link.

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

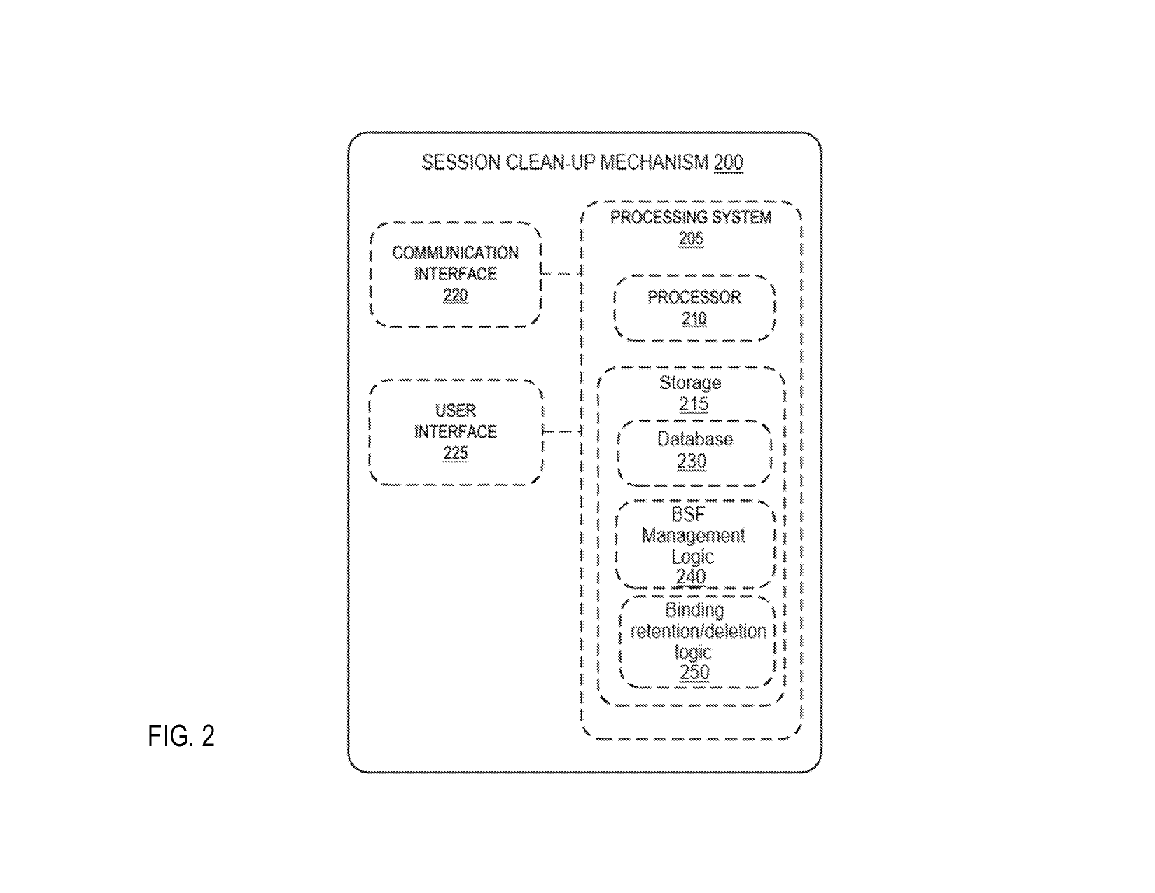

FIG. 2 illustrates a session clean-up mechanism 200 in accordance with embodiments described herein. The components described herein are merely exemplary as many different configurations for the session clean-up mechanism 200 may be implemented. The session clean-up mechanism 200 may be configured to perform the methods and operations disclosed herein to dynamically ensure that the SMF150, the PCF 160 and the BSF 170 remain synchronized with respect to session retention and deletion. In the disclosed embodiments, the session clean-up mechanism 200 may be integrated with the core network 102, for example with the BSF 170, or may be an entirely separate component capable of communicating with at least the BSF 170 of the core network 102. Further, the components of the session clean-up mechanism 200 may be distributed so that one or more components are located within the SMF150, the PCF 160, the BSF 170, and/or a separate processing node in communication with or integrated with the core network 102.

The session clean-up mechanism 200 may be configured for performing the operations described herein to render a decision whether a session binding of an application or a device should be kept or deleted, by utilizing processing system 205. Processing system 205 may include a processor 210 and a storage device 215. Storage device 215 may include a random access memory (RAM), read-only memory (ROM), disk drive, a flash drive, a memory, or other storage device configured to store data and/or computer readable instructions or codes (e.g., software), subscriber/user session, session bindings with various network slices, etc.. The computer executable instructions or codes may be accessed and executed by processor 210 to perform various methods disclosed herein. Software stored in storage device 215 may include computer programs, firmware, or other form of machine-readable instructions, including an operating system, utilities, drivers, network interfaces, applications, or other type of software. For example, software stored in storage device 215 may include a module for performing various operations described herein.

For example, BSF management logic 240 may ensure that the BSF 170 removes a session binding from a database upon receiving a notification, for example from the PCF 160, regardless of whether the SMF 150 is able to reach the PCF 160, and regardless of whether the PCF 160 is able to reach the BSF 170. Binding retention/deletion logic 250 may be utilized by and/or incorporated in the BSF 170 to implement a mechanism for the BSF 170 to make an inquiry regarding existing session bindings, such as an operator timer, for example.

Further, the storage area 215 may include a database 230. The database 230 may store active session bindings. To perform the above-described operations, the BSF management logic 240 and the binding retention/deletion logic 250 may be executed by the processor 210 to operate on the database 230 to manage device/application sessions and thus also synchronization between the SMF 150, the PCF 160 and the BSF170.

Processor 210 may be a microprocessor and may include hardware circuitry and/or embedded codes configured to retrieve and execute software stored in storage device 215. The session clean-up mechanism 200 further includes a communication interface 220 and a user interface 225. Communication interface 220 may be configured to enable the processing system 205 to communicate with other components, nodes, or devices in the wireless network.

Communication interface 220 may include hardware components, such as network communication ports, devices, routers, wires, antenna, transceivers, etc. User interface 225 may be configured to allow a user to provide input to the session clean-up mechanism 200 and receive data or information from other system components. User interface 225 may include hardware components, such as touch screens, buttons, displays, speakers, etc.

The location of the session clean-up mechanism 200 may depend upon the network architecture. As set forth above, the session clean-up mechanism 200 may be located in the core network 102, in a separate processing node, in the BSF 170, in multiple locations such as the SMF 150, PCF 160, and/or BSF 170, or may be an entirely discrete component. Further, although shown as a single integrated system, the functions of BSF session clean-up logic may be separated and be disposed in separate locations. For example, the BSF management logic 240 may be disposed in the PCF 160 and the binding retention/deletion logic 250 may be disposed in the BSF 170.

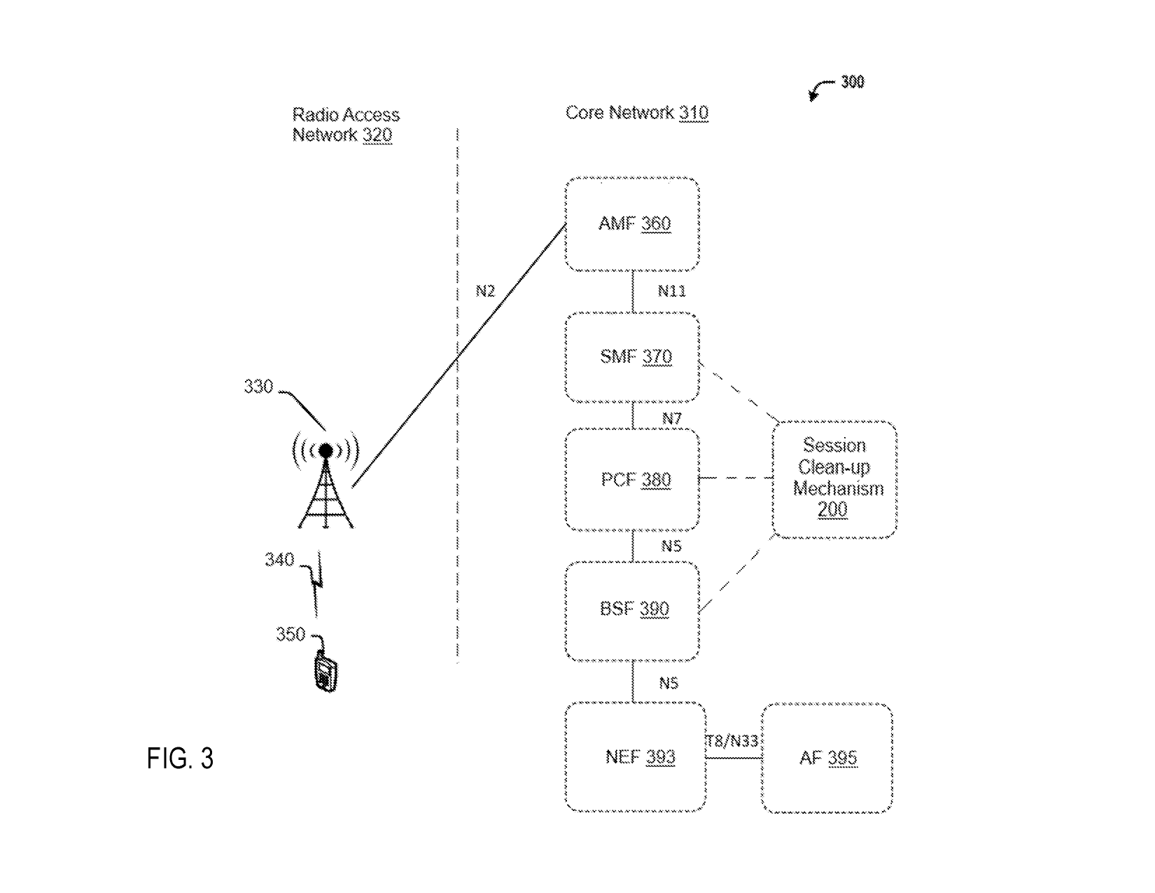

FIG. 3 depicts an environment 300 showing a session clean-up mechanism 200 communicating with network functions within the core network 310 in accordance with an embodiment. FIG. 3 additionally illustrates the wireless device 350 communicating with the access node 330 over the wireless communication link 340. The access node 330 communicates with the control plane functions of the core network 310 by communicating with an AMF 360 over an N2 interface.

Within the control plane of the core network 310, multiple network functions communicate with one another to establish and terminate quality on demand subscriptions. Within the control plane, an AMF 360, an SMF 370, PCF 380, a BSF 390, NEF 393, and AF 395 are illustrated. These components communicate over the illustrated interfaces. For example, the AMF 360 can receive connection requests over interface N2 from one or more wireless devices via access node 330, and manage tasks associated with connection or mobility management, while forwarding session management requirements over an N11 interface to the SMF 370. Meanwhile, the SMF 370 communicates over an N7 interface with the PCF 380. The BSF 390 may function as a proxy between the PCF 380 and NEF 393, communicating using an N5 interface.

The BSF 390 plays a key role in session binding management, through interaction with the PCF 380. The AF 395 accesses the NEF 393 for retrieving resources and interacts with the PCF 380 to enable policy control. The AF 395 further provides application services to subscribers. As illustrated, the session clean-up mechanism 200 may be incorporated in or communicate with the SMF 370, the PCF 380, and/or the BSF 390. Further, the session clean-up mechanism 200 may operate as a processing node in communication with the SMF 370, the PCF 380, and/or the BSF 390, in order to trigger these network functions to perform the operations described herein.

All of the illustrated network functions can include a processor, a memory, and may be configured to perform the various functions described herein. Further, each network function can associate with different reference points, including reference points for data transmission between different network nodes and reference points for control signal transmission between different network nodes.

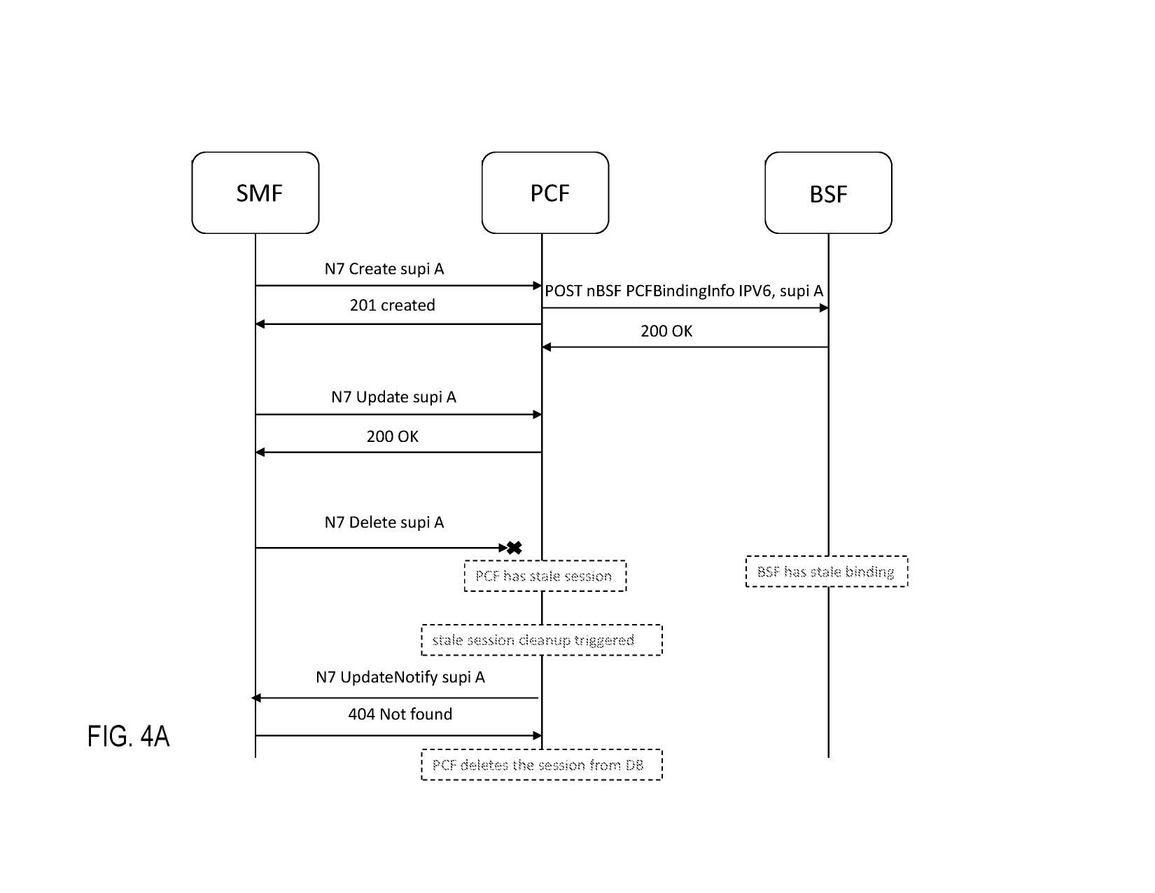

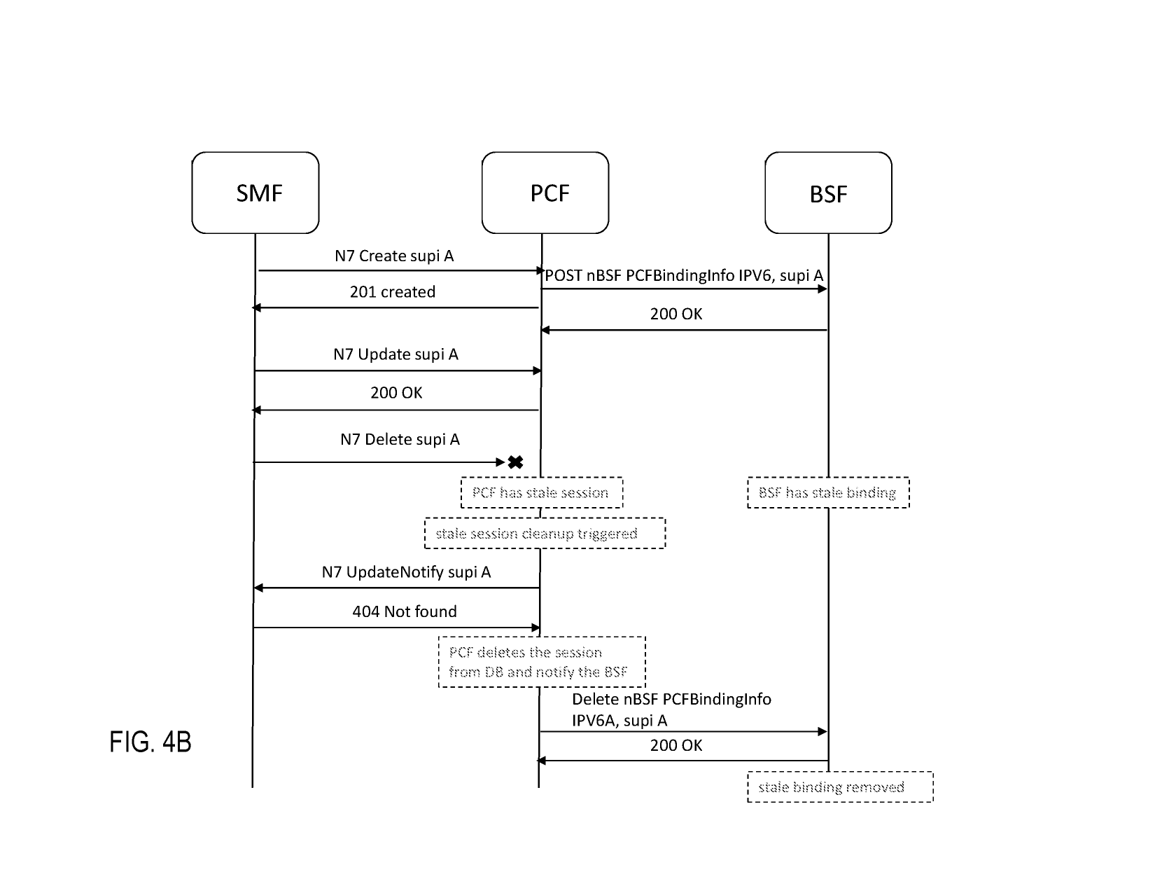

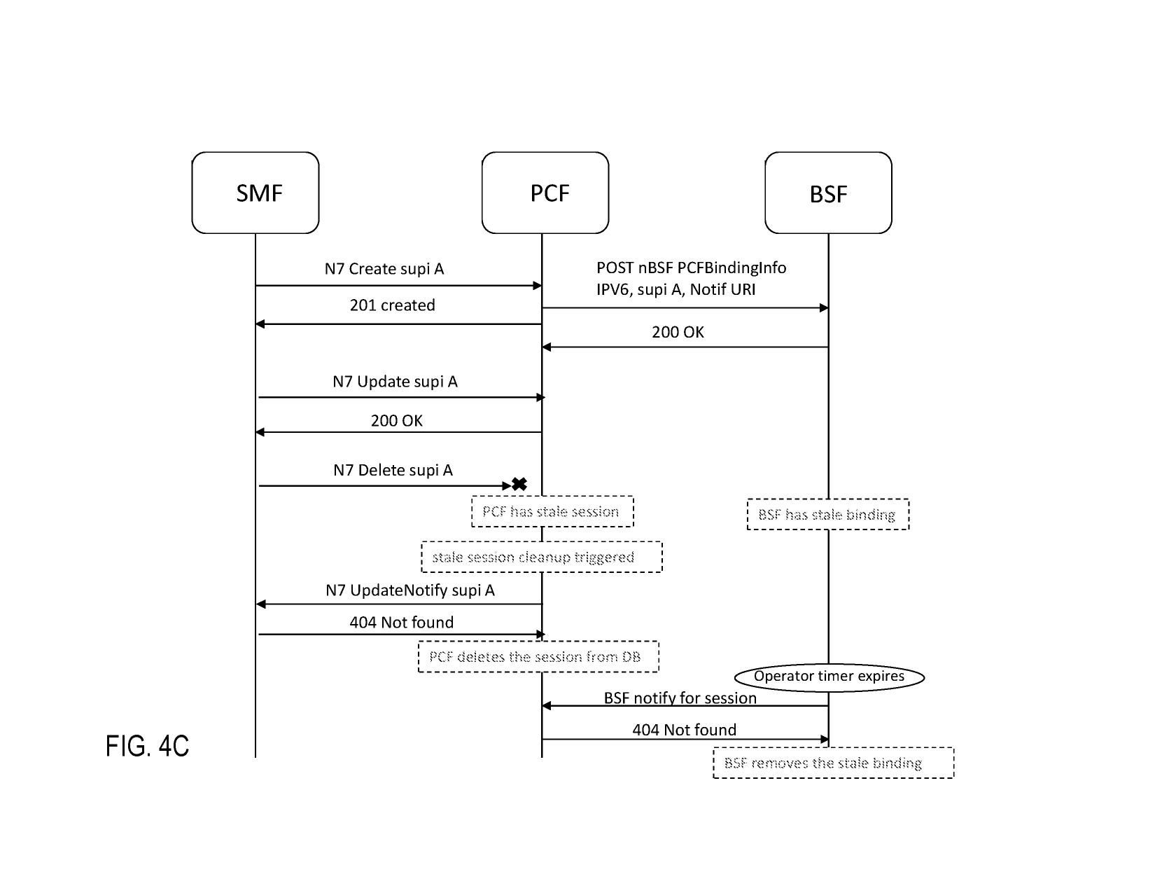

FIGS. 4A-C are diagrams exemplifying certain interactions of control plane functions with and without session clean-up mechanism. Turning to FIG. 4A, when the PDU session is established by the SMF, the PCF sends an acknowledgment/confirmation message, e.g., a 201 message to the SMF that the PDU session is created. Then, the PCF copies this information to the BSF. The session formed, for example, by a mobile subscriber that is identified by a subscription permanent identifier (SUPI) is stored by the BSF according to the session’s binding information identified by the internet protocol version 6 (IPv6), for example. The BSF sends an acknowledgment/confirmation message, e.g., a 200 message to the PCF that the PDU session binding is created. The session by the mobile subscriber may be maintained, updated or eventually deleted.

In instances when the SMF updates a session, the SMF notifies the PCF, when a confirmation notification, e.g., a 200 message is sent back from the PCF to the SMF. In certain instances (not shown), when the SMF deletes a session, the SMF sends an N7 message to inform the PCF and the PCF responds with an acknowledgement notification to the SMF, and as a result, the PCF deletes the session from the database. Nonetheless, FIG. 4A illustrates an example when the SMF deletes a session, but a N7 does not reach the PCF for the PCF to be notified of the session removal event. For example, when the SMF releases an IPv6 address due to UE deregistering from the network, the network may be congested, or the PCF may otherwise not be able to process the notification to delete. Consequently, the PCF has a stale session.

In certain cases, the PCF may have its own session clean up mechanism based on respective vendors/operators. The PCF may audit the stale sessions and send an N7 notification to instruct the SMF to determine whether a stale session is active or not, and if the SMF does not respond, e.g., due to inability to locate the session, the PCF removes the inactive session from the database as a result of receiving a 404 message.

However, in some instances, such as an example shown in FIG. 4A, the PCF may not automatically alert the BSF of the session deletion resulting from the PCF clean-up, and the BSF is not informed of the session removal, thus not removing the session binding from the database as a result. In this manner, stale bindings may linger and the same subscriber may have multiple session requests on the network, thereby wastefully using up the storage capacity of the network database.

FIGS. 4B and 4C show different solutions to the BSF stale binding problem. In the embodiment shown in FIG. 4B, upon performing the stale session cleanup, as explained above, the PCF is configured to notify the BSF next, thus allowing the BSF the benefit of the PCF cleanup mechanism. Accordingly, even when the SMF deletes a session, but a N7 does not reach the PCF, the sequence of the PCF’s session cleanup and subsequent notification provided to the BSF results in the BSF replying with a 200 message, thus acknowledging the deleting of the session by the PCF. As a result, the BSF removes the binding of the deleted session from the database.

In the embodiment shown in FIG. 4C, the session clean-up mechanism encounters the same issue shown in FIG. 4A but provides a different solution as compared to the solution provided in the embodiment of FIG. 4B. Namely, in the diagram depicted in FIG. 4C, the PCF performs its own session clean-up process even when the N7 deletion notification does not arrive from the SMF properly to the PCF. Similar to FIG. 4B, the PCF performs the audit on the SMF and receives information that the inquired session has been deleted, since the 404 message indicates that the removed session cannot be found. However, at this juncture, the PCF has the information of the session removal, but the BSF does not. Therefore, the BSF has a stale binding lingering in the database.

Nonetheless, in the embodiment of FIG. 4C, the session clean-up mechanism includes an operator timer in the BSF, which allows the BSF to operate uninterrupted for a certain period of time, regardless of whether there are any stale bindings present. After a period of time set by the operator timer, the operation of the BSF is interrupted, and the BSF audits the PCF for the particular session(s). Being that the PCF has been informed of the deleted sessions due to its own session clean-up process, the session is no longer active. Consequently, the PCF responds to the BSF with a 404 message indicating that the session has been removed, and the BSF processes the 404 message to subsequently remove the session binding from the database, as well. In this manner, stale bindings are removed by the BSF. On the other hand, because the BSF may be configured to render the removal/retention decision based on the reply provided by the PCF, in case that the PCF responds with a 200 OK message, the BSF would not perform binding deletion and the session binding would remain in the database as a consequence.

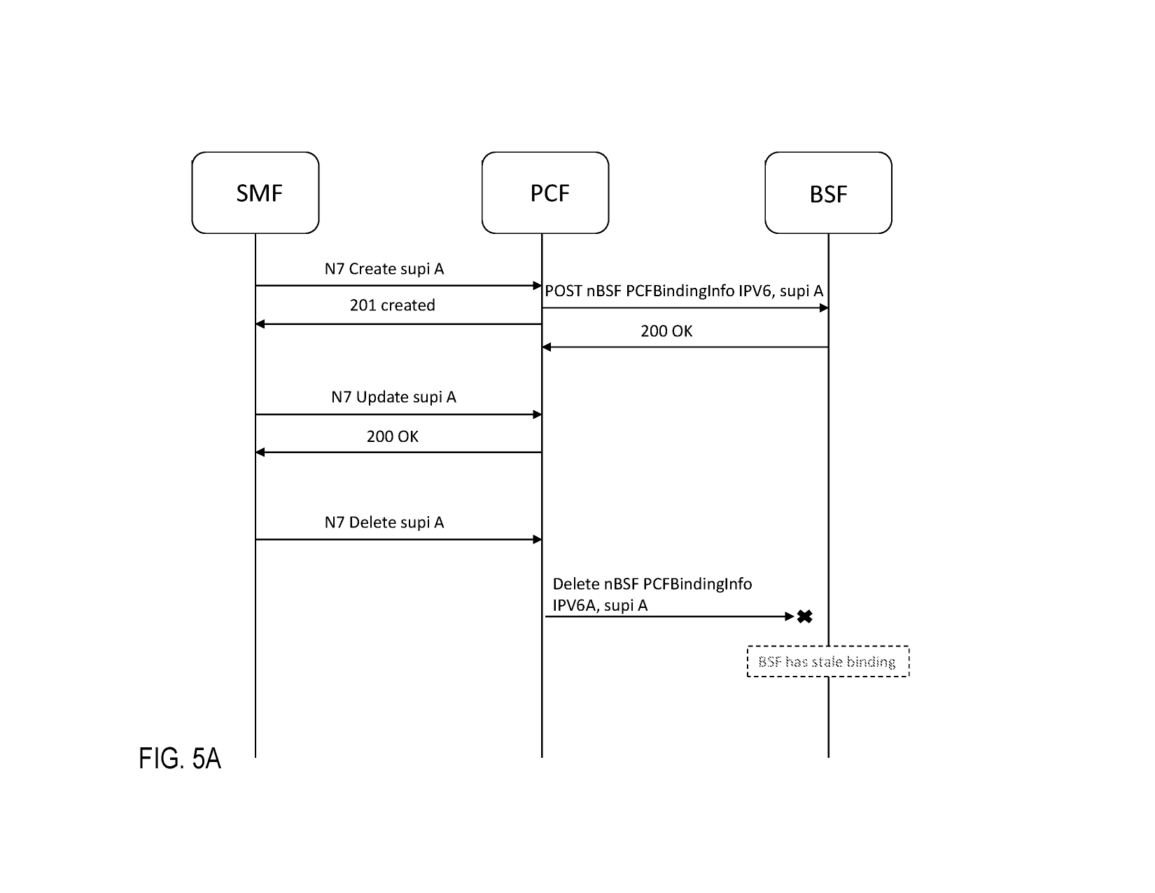

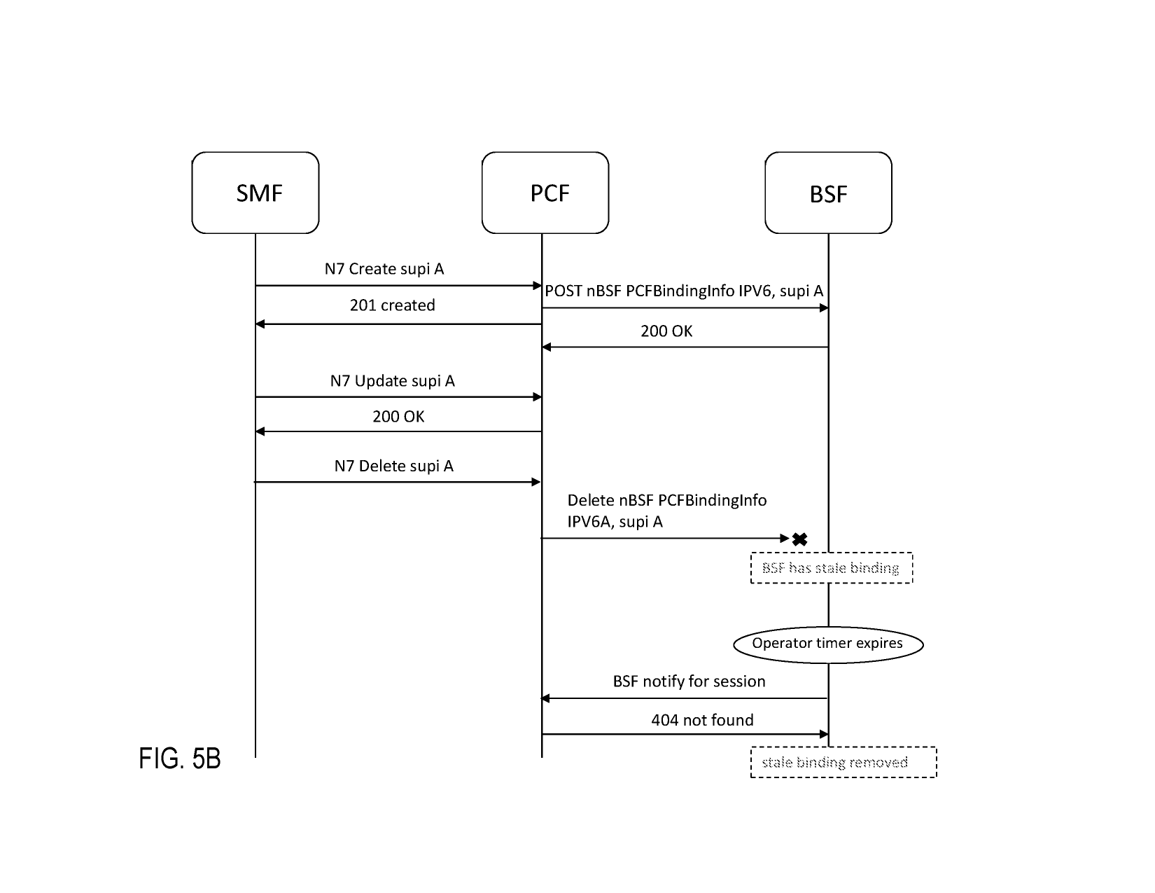

Turning to FIG. 5A, when the PDU session is established by the SMF, the PCF sends an acknowledgment/confirmation message, e.g., a 201 message to the SMF that the PDU session is created. Then, the PCF copies this information to the BSF. The session formed, for example, by a mobile subscriber that is identified by a subscription permanent identifier (SUPI) is stored by the BSF according to the session’s binding information identified by the internet protocol version 6 (IPv6), for example. The BSF sends an acknowledgment/confirmation message, e.g., a 200 message to the PCF that the PDU session binding is created. The session by the mobile subscriber may be maintained, updated or eventually deleted.

In instances when the SMF updates a session, the SMF notifies the PCF, when a confirmation notification, e.g., a 200 message is sent back from the PCF to the SMF. In certain instances (not shown), when the SMF deletes a session, the SMF sends an N7 message to inform the PCF and the PCF responds with an acknowledgement notification to the SMF, and as a result, the PCF deletes the session from the database.

Nonetheless, FIG. 5A illustrates an example when the PCF deletes a session, and the PCF attempts to copy this information to the BSF. Next, the PCF sends a notification to the BSF to delete the binding, but due to the network congestion or another reason why the BSF is unable to process the removal notification, the BSF does not remove the binding, which in turn remains stale in the database.

In the embodiment of FIG. 5B, the session clean-up mechanism includes an operator timer in the BSF, which allows the BSF to operate uninterrupted for a certain period of time, regardless of whether there are any stale bindings present, similar to FIG. 4C. After a period of time set by the operator timer, the operation of the BSF is interrupted, and the BSF audits the PCF for the particular session(s). Being that the PCF has been informed of the deleted session by the SMF, the session is no longer active. Consequently, the PCF responds to the BSF with a 404 message indicating that the session has been removed, and the BSF processes the 404 message to subsequently remove the session binding from the database, as well. In this manner, any stale bindings are removed by the BSF. On the other hand, because the BSF may be configured to render the removal/retention decision based on the reply provided by the PCF, in case that the PCF responds with a 200 OK message, the BSF would not perform biding deletion and the session binding would remain in the database as a result.

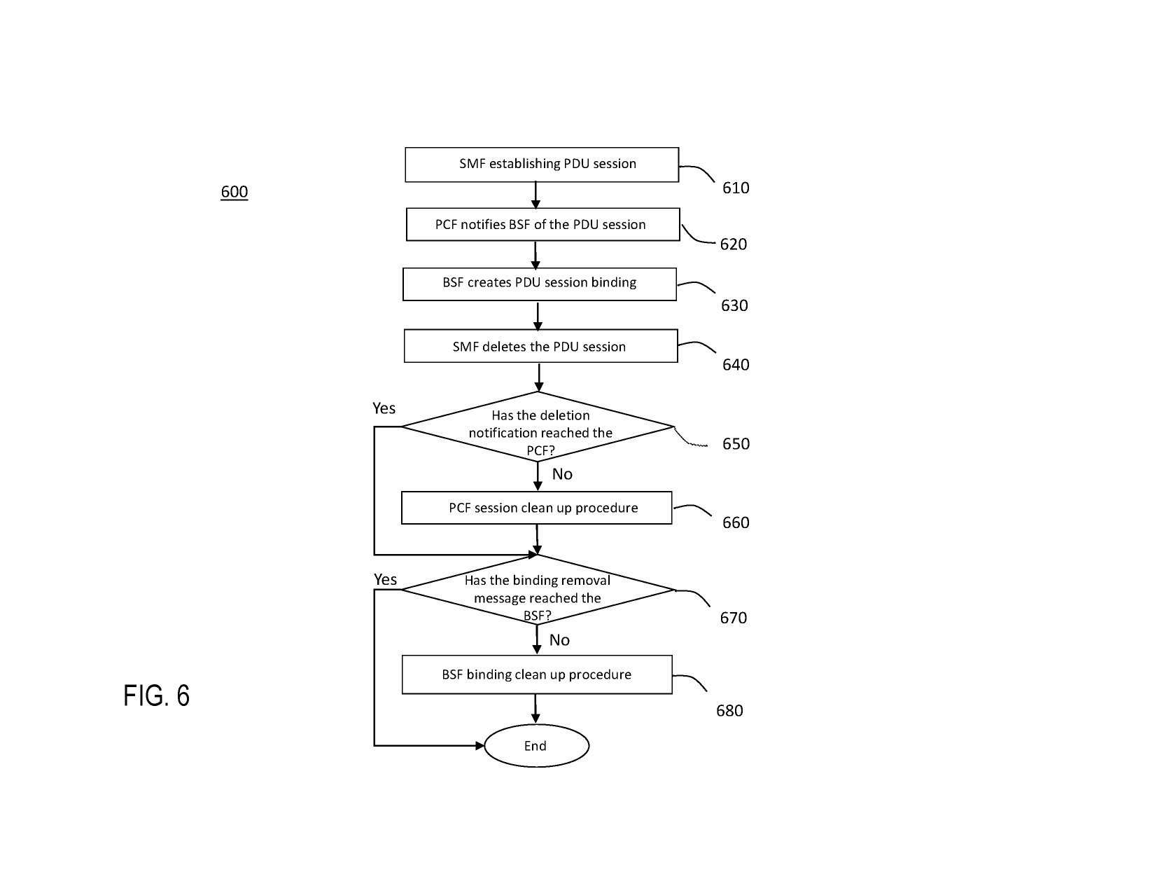

FIG. 6 depicts a further exemplary method 600 for session clean-up procedure in accordance with an embodiment. Method 600 may be performed by any suitable processor discussed herein, for example, the processor 210 included in the session clean-up mechanism 200 or in the BSF 170. For discussion purposes, as an example, method 600 is described as being performed by the processor 210 included in the session clean-up mechanism 200, which may be wholly or partially incorporated in the BSF 170.

Method 600 starts in step 610, in which the PDU session is established by the SMF. The PCF sends an acknowledgment/confirmation message, e.g., a 201 message to the SMF that the PDU session is created. Then, in step 620, the PCF copies this information to the BSF. The session formed, for example, by a mobile subscriber that is identified by a subscription permanent identifier (SUPI) is stored by the BSF in step 630, according to the session’s binding information identified by the internet protocol version 6 (IPv6), for example. The BSF sends an acknowledgment/confirmation message, e.g., a 200 message to the PCF that the PDU session binding is created.

In step 640, the SMF deletes a session, and sends a N7 notification to the PCF in attempts to inform the PCF of the session removal. In step 650, the PCF session clean-up mechanism makes a determination whether the notification has reached the PCF. If the determination is affirmative, the PCF is appraised of the session deletion and removes the policy session. On the other hand, if the N7 message has not reached the PCF, the PCF performs a session clean up procedure in step 660. The PCF may audit the stale sessions and send an N7 notification to instruct the SMF to determine whether a stale session is active or not, and if the SMF does not respond, e.g., due to inability to locate the session, the PCF removes the inactive session from the database as a result of receiving a 404 message.

In step 670, the BSF session binding clean-up mechanism determines whether, upon removing the stale session, the notification has been sent from the PCF to the BSF at all to delete a session biding, and if sent, whether the information has reached the BSF. If the PCF has informed the BSF, and session biding is deleted from the database, the session binding clean-up is completed. However, if in step 670 it is determined that the binding removal notification has not reached the BSF, the BSF binding clean up procedure is applied in step 680.

The session binding clean up mechanism includes an operator timer in the BSF, which allows the BSF to operate uninterrupted for a certain period of time, regardless of whether there are any stale bindings present, as shown in FIGS. 4C and 5B. After a period of time set by the operator timer, the operation of the BSF is interrupted, and the BSF audits the PCF for the particular session(s). Being that the PCF has been informed of the deleted session, either by the N7 notification from the SMF, or by the PCF’s own clean up process, the session is no longer active. Consequently, the PCF responds to the BSF with a 404 message indicating that the session has been removed, and in step 680, the BSF processes the 404 message to subsequently remove the session binding from the database, as well. In this manner, any stale bindings are removed by the BSF, and the session binding clean-up is completed.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
creating a session binding for a session in a wireless network database,
when the session is inactive, determining whether a session binding removal notification from a policy control function (PCF) to delete the session binding from the wireless network database has reached a binding support function (BSF), and
in response to determining that the session binding removal notification has not reached the BSF, removing the session binding at the BSF.

2. The method of claim 1, further comprising:
establishing the session in the wireless network database by a session management function (SMF) and notifying the PCF by the SMF; and
instructing the BSF, by the PCF, to create the session binding in the wireless network database.

3. The method of claim 2, the method comprising:
deleting the session on the network by the SMF;
determining whether a session deletion notification from the SMF has reached the PCF; and
in response to determining that the session deletion notification has not reached the PCF, deleting the session binding at the PCF.

4. The method of claim 1, wherein, upon expiration of a predetermined period of time, the BSF queries the PCF for a session for the session binding.

5. The method of claim 4, wherein, in response to the query by the BSF, the PCF returns an error message to the BSF indicating the session for the session binding is inactive.

6. The method of claim 5, further comprising, in response to receiving the error message, deleting the session binding at the BSF.

7. The method of claim 1, wherein the PCF queries a session management function (SMF) for a session for the session binding.

8. The method of claim 7, wherein, in response to the query by the PCF, the SMF returns an error message to the PCF indicating the session for the session binding is inactive.

9. The method of claim 8, further comprising, in response to receiving an error message from the SMF, deleting the session binding at the PCF.

10. A system comprising:
a memory storing instructions and data including a subscription uplifting a quality of service for a wireless device; and
at least one processor executing the stored instructions to perform operations including:
create a session binding in a wireless network database,
determine whether a session binding removal notification from a policy control function (PCF) to delete the session binding from the wireless network database has reached a binding support function (BSF), and
in response to determining that the session binding removal notification has not reached the BSF, remove the session binding at the BSF.

11. The system of claim 10, wherein the operations further comprise:
establish the session in the wireless network database by a session management function (SMF) and notify the PCF by the SMF; and
instruct the BSF, by the PCF, to create the session binding in the wireless network database.

12. The system of claim 11, wherein the operations further comprise:
delete the session on the network by the SMF;
determine whether a session deletion notification from the SMF has reached the PCF; and
in response to determining that the session deletion notification has not reached the PCF, delete the session binding at the PCF.

13. The system of claim 10, wherein, upon expiration of a predetermined period of time, the BSF queries the PCF for a session for the session binding.

14. The system of claim 13, wherein, in response to the query by the BSF, the PCF returns an error message to the BSF indicating the session for the session binding is inactive.

15. The system of claim 14, wherein the operations further comprise:
in response to receiving the error message, delete the session binding at the BSF.

16. The system of claim 10, wherein the PCF queries a session management function (SMF) for a session for the session binding.

17. The system of claim 16, wherein, in response to the query by the PCF, the SMF returns an error message to the PCF indicating the session for the session binding is inactive.

18. The system of claim 17, wherein the operations further comprise:
in response to receiving an error message from the SMF, delete the session binding at the PCF.

19. A non-transitory computer readable medium storing instructions executed by a processor to perform operations comprising:
creating a session binding in a wireless network database,
determining whether a session binding removal notification from a policy control function (PCF) to delete the session binding from the wireless network database has reached a binding support function (BSF), and
in response to determining that the session binding removal notification has not reached the BSF, removing the session binding at the BSF.

20. The non-transitory computer readable medium of claim 19, wherein the operations further comprise:
establishing the session in the wireless network database by a session management function (SMF) and notifying the PCF by the SMF; and
instructing the BSF, by the PCF, to create the session binding in the wireless network database.
